(19) United States
(12) Patent Application Publication
(10) Pub. No.: US 2013/0078849 A1
(43) Pub. Date: Mar. 28, 2013

(54) CONNECTOR ILLUMINATION STATUS

(71) Applicant: Stephen L. Silva, N. Billerica, MA (US)

(72) Inventor: Stephen L. Silva, N. Billerica, MA (US)

(73) Assignee: AVAYA INC., Basking Ridge, NJ (US)

(21) Appl. No.: 13/241,507

(22) Filed: Sep. 23, 2011

(51) Int. Cl. H01R 3/00

(52) U.S. Cl. 439/490

(57) ABSTRACT

Methods and apparatus provide for a light-conductive housing of a status-indicating connector. The status-indicating connector has an engagement portion attached to the light-conductive housing. The engagement portion places the status-indicating connector in electrical communication with a circuit board. An illuminative portion of the light-conductive housing can be illuminated by light delivered via the light-conductive housing of the status-indicating connector. The illuminative portion of the light-conductive housing is illuminated by the light based on a current status of a connection between the engagement portion and the circuit board. The light is provided by an external light source associated with the circuit board or a light source internal to the status-indicating connector.

### BACKGROUND

“Modular connector” is the name given to a family of electrical connectors commonly used for telephone systems, data networks, and low-speed serial connections. Modular connectors are a cornerstone of communications technology and have been used in the telecommunications and Ethernet industry for many years due to their simplicity and reliability. A modular connector typically has a clear, plastic body, with a tab that locks the plug and jack into place when connected. In the vernacular used by the technology industry, they are called “RJ” connectors. An RJ-12 connector has a 6-position, 6-conductor arranged in a single row. The RJ-12 connector is often used for voice/data applications, such as telephone (two-line), networking and extended-distance peripherals. An 8-position, 8-conductor modular connector is most often used for data networks, such as Ethernet. RJ-45 connectors are physically wider than the RJ-11/12 connectors used for telephone. In network applications, RJ-45 cable assemblies are used to connect from a patch panel to a network switch, and also to connect a computer's network interface card to a data port. Whether integrated in a simple telephone system, or in a gigabit application, modular connectors are inexpensive, relatively simple to terminate, and easy to plug and unplug.

### BRIEF DESCRIPTION

Conventional electronic module faceplates now provide a multitude of individual modular connector/jack connections. Light emitting diodes (LED) are often positioned above, below or to the side of each modular connector/jack connection to provide a visible indication of the status of the corresponding connection. However, as current faceplates become more dense with modular connector/jack connections, the LEDs are difficult to see and can end up taking valuable faceplate space. In addition, since modern faceplates become crowded with many cables leading to active individual modular connector/jack connections, it can also be difficult to discern each connection's corresponding LED.

Techniques discussed herein significantly overcome the deficiencies of conventional modular connectors such as those discussed above. As will be discussed further, certain specific embodiments herein are directed to a status-indicating connector. The status-indicating connector has an engagement portion that connects the status-indicating connector with a circuit board. In other words, the engagement portion of the status-indicating connector can be inserted into a connection jack provided on a faceplate of a computer device, such as a server. The status-indicating connector has a light-conductive housing with at least a portion of a data transmission medium, such as a cable, disposed within the light-conductive housing. The light-conductive housing delivers light, from a light source, to illuminate at least an illuminative portion of the light-conductive housing.

The illuminative portion of the light-conductive housing is illuminated by the delivered light in order to indicate a status of the data link between the circuit board and the status-indicating connector and/or the data transmission medium received within the status-indicating connector's light-conductive housing. The light source can be provided by the circuit board's LED and/or can be integrated within the light-conductive housing itself. It is also understood that the light source can provide different light colors where each different color represents a different type of data link status.

The status-indicating connector discussed herein thereby overcomes the deficiencies of conventional modular connectors. The status-indicating connector removes the need for a visible LED for each modular connector/jack connection on a faceplate. By utilizing many status-indicating connectors, a faceplate that is dense with many cables leading to multiple modular connector/jack connections can better utilize the space that would otherwise have been used for each visible LED. In addition, a person viewing the status indicated by the status-indicating connector will not be confused as to the exact status of the data link associated with the particular status-indicating connector.

In another embodiment, at least a portion of the connection jack (hereinafter “jack”) is light-conductive. The jack can be disposed on a computing device and be accessible to a modular connector via the computing device's faceplate. At least a portion of the connector is received by the jack to form a data connection. Light from a circuit board in communication with the jack is received by the light-conductive portion of the jack. The light-conductive portion of the jack allows the light to travel to an illuminative portion of the jack. The light is received at the illuminative portion and the received light illuminates the jack's illuminative portion. The jack's illuminative portion thereby displays the received light to indicate a status of the data connection between the jack and the connector.

Other embodiments disclosed herein can be connected to any type of computerized device, workstation, handheld or laptop computer, or circuitry (e.g., a processor) to perform any or all of the method operations disclosed herein. In other words, a computerized device such as a computer or a data communications device or any type of processor that is programmed or configured to operate as explained herein is considered an embodiment disclosed herein.

The embodiments disclosed herein, may be employed with respect to software and hardware such as those manufactured by Avaya, Inc. of Basking Ridge, N.J.

Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

Note also that this Brief Description section herein does not specify every embodiment and/or incrementally novel aspect of the present disclosure or claimed invention. Instead, this Brief Description only provides a preliminary discussion of different embodiments and corresponding points of novelty over conventional techniques. For additional details and/or possible perspectives (permutations) of the invention, the reader is directed to the Detailed Description section and corresponding figures of the present disclosure as further discussed below.

### BRIEF DESCRIPTION OF THE DRAWINGS

The foregoing and other objects, features and advantages of the invention will be apparent from the following more particular description of embodiments of the methods and apparatus for a status-indicating connector, as illustrated in the accompanying drawings and figures in which like reference characters refer to the same parts throughout the different views. The drawings are not necessarily to scale, with emphasis instead being placed upon illustrating the embodiments, principles and concepts of the methods and apparatus in accordance with the invention.

FIG. 1 is an example block diagram of a view of an engagement portion of a status-indicating connector with a light-conductive housing according to embodiments herein.

FIG. 2 is an example block diagram of a view of an illuminative portion of a status-indicating connector with a light-conductive housing according to embodiments herein.

FIG. 3 is a flowchart of an example of processing steps to connect an engagement portion of a status-indicating connector to a circuit board according to embodiments herein.

FIG. 4 is a flowchart of an example of processing steps to indicate a status of a transmission link between the status-indicating connector and a circuit board according to embodiments herein.

FIG. 5 is a flowchart of an example of processing steps to receive a modular connector within a connection jack according to embodiments herein.

FIG. 6 is an example block diagram of a view of at least a portion of a connection jack according to embodiments herein.

### DETAILED DESCRIPTION

Methods and apparatus provide for a light-conductive housing of a status-indicating (“S-I”) connector. The S-I connector has an engagement portion attached to the light-conductive housing. The engagement portion places the S-I connector in electrical communication with a circuit board. An illuminative portion of the light-conductive housing can be illuminated by light delivered via the light-conductive housing of the S-I connector. The illuminative portion of the light-conductive housing is illuminated by the light based on a current status of a connection between the engagement portion and the circuit board. The light is provided by an external light source associated with the circuit board or a light source internal to the S-I connector.

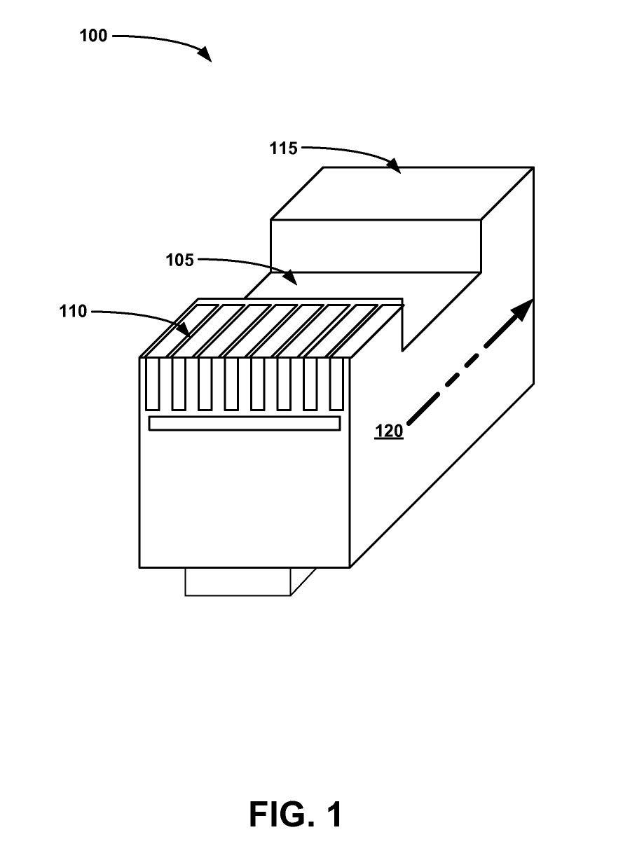

FIG. 1 is an example block diagram of a view of an engagement portion 110 of a status-indicating connector 100 with a light-conductive housing 105 according to embodiments herein. As shown, in this particular embodiment, the S-I connector 100 can be an improvement of an 8-position, 8-conductor modular connector. The shape and design of the status-indicating connector 100 illustrated in the FIG. 1 is not meant to limit any embodiments of the status-indicating connector 100.

When the S-I connector 100 connects to a circuit board, such as by inserting pins on the engagement portion 110 into a modular connector jack, an external light source associated with the circuit board provides light 120 to the S-I connector 100. The light-conductive housing 105 of the S-I connector 100 allows the light to channel throughout the S-I connector 100. The light-conductive housing 105 delivers the light 120 to the illuminative portion 115 of the S-I connector 100. The light 120 therefore illuminates the illuminative portion 115 to indicate a current status of the connection between the S-I connector 100 and the circuit board.

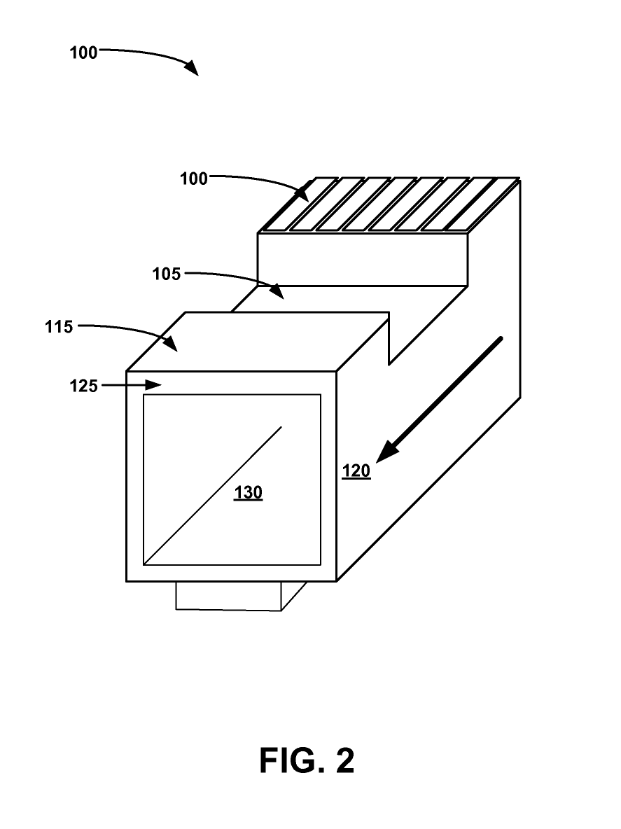

FIG. 2 is an example block diagram of a view of an illuminative portion 115 of a status-indicating connector 100 with a light-conductive housing 105 according to embodiments herein.

In FIG. 2, light 120 travels through the light-conductive housing 105 of the S-I connector 100. The light 120 can be provided by an external light source or an internal light source. For example, at least one light emitting diode can be integrated with the S-I connector 100 and can provide the light from within and through the light-conductive housing 105 in order to illuminate an externally exposed surface 125 of the illuminative portion 115.

Additionally, the light-conductive housing 105 includes an internal chasm 130 in which at least a portion of a data transmission medium, such as a cable, can be housed. The data transmission medium provides data to and receives data from the circuit board when the S-I connector 100 is connected to the circuit board via the engagement portion 110. In another embodiment, the light source (whether internal or external) can provide different colors of light so as to illuminate the externally exposed surface 125 according to the different colors so as to indicate varying status levels of the data link between the data transmission medium and the circuit board.

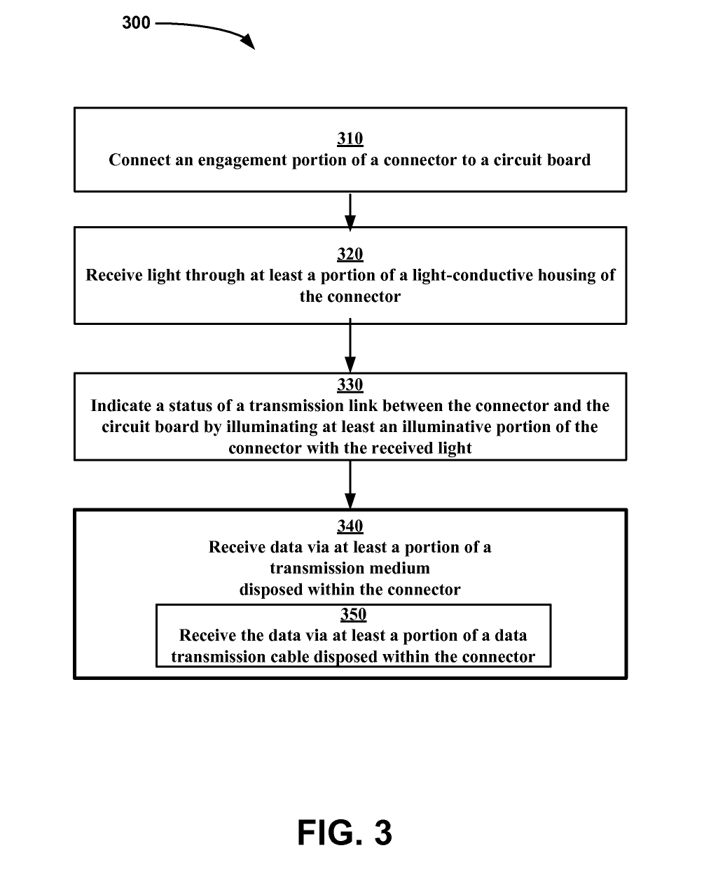

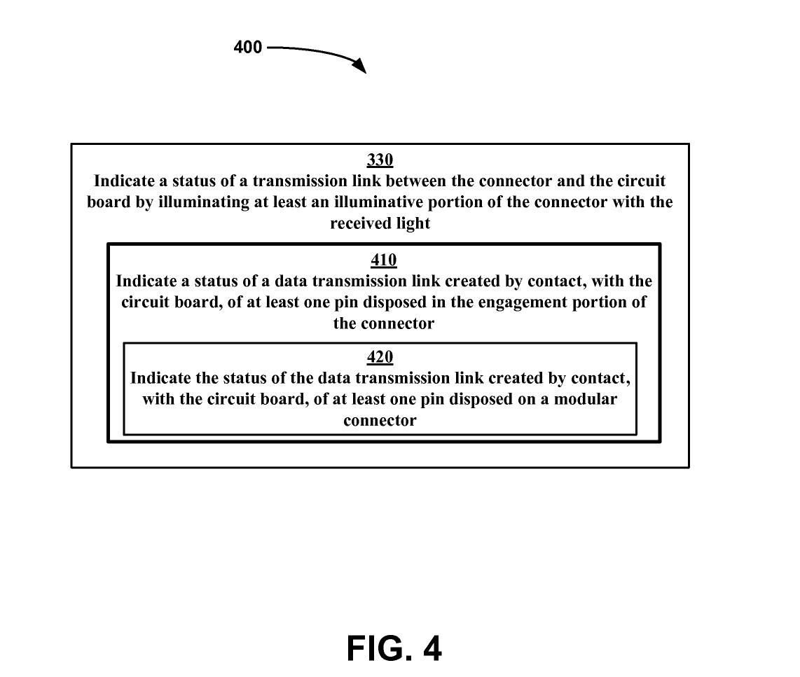

Turning now to FIG. 3 and FIG. 4, it will be appreciated by those of ordinary skill in the art that unless otherwise indicated herein, the particular sequence of steps described in flowcharts 300, 400 are illustrative only and may be varied without departing from the spirit of the invention. Thus, unless otherwise stated, the steps described below are unordered, meaning that, when possible, the steps may be performed in any convenient or desirable order.

FIG. 3 is a flowchart 300 of an example of processing steps to connect an engagement portion of a status-indicating connector (hereinafter “connector”) to a circuit board according to embodiments herein.

At step 310, an engagement portion of the connector connects to a circuit board. For example, the connector's engagement portion interlocks with a modular connector jack. The connector and the circuit board can thereby electrically communicate by way of the connection established between the connector's engagement portion and the modular connector jack.

At step 320, at least a portion of a light-conductive housing of the connector receives light. The light can be provided from a light source external to the connector or a light source internal to the connector. The external light source can be a light source associated with the circuit board. The internal light source can be a light source within the connector itself. Either light source can be a light emitting diode in various embodiments.

At step 330, illuminate at least an illuminative portion of the connector with the received light in order indicate a status of a transmission link between the connector and the circuit board. In step 330, the light-conductive housing allows the light from the light source to travel throughout various portions of the connector towards the illuminative portion. It is noted that the light source can be a multi-colored light source, where each different color can be associated with a different type of status of the transmission link.

At step 340, receive data via at least a portion of a transmission medium disposed within the connector. At step 345, receive the data via at least a portion of a data transmission cable disposed within the connector.

FIG. 4 is a flowchart 400 of an example of processing steps to indicate a status of a transmission link between the status-indicating connector (hereinafter “connector”) and a circuit board according to embodiments herein.

At step 410, indicate a status of a data transmission link created by contact, with the circuit board, of at least one pin disposed in the engagement portion of the connector.

At step 420, indicate the status of the data transmission link created by contact, with the circuit board, of at least one pin disposed on a modular connector.

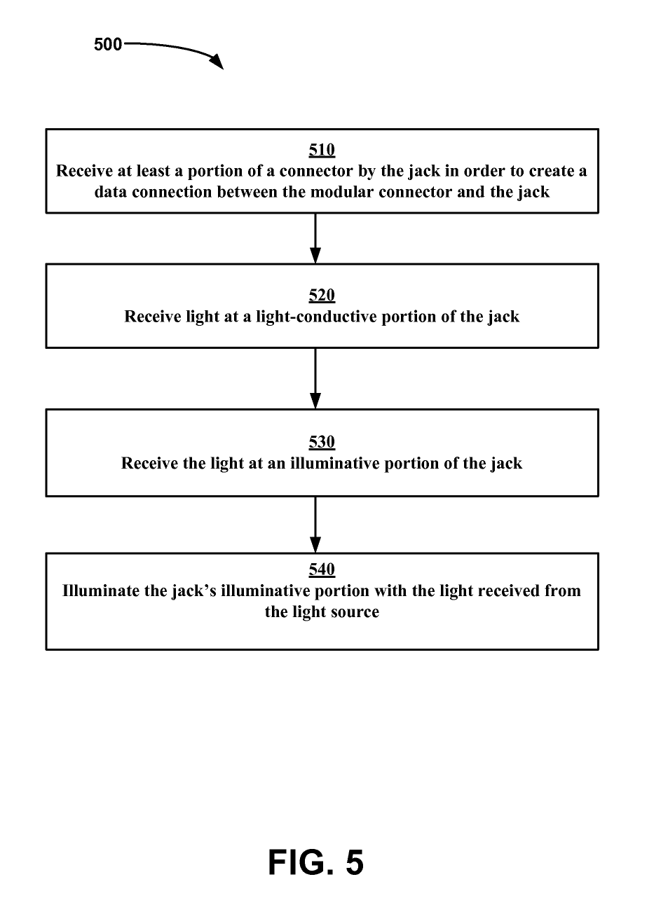

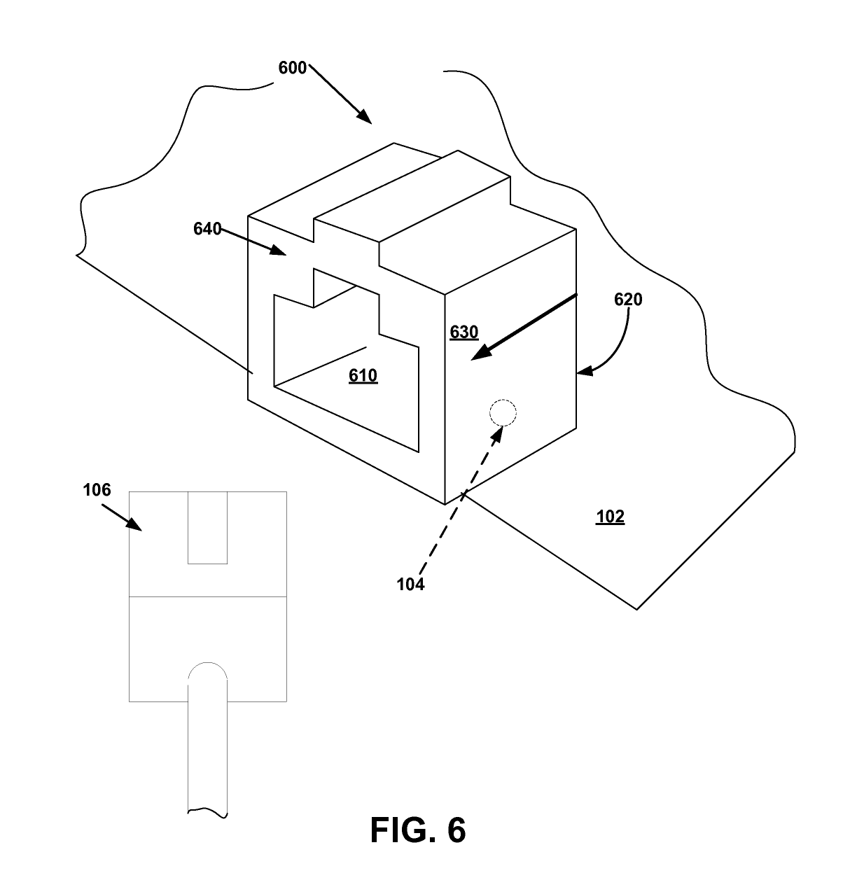

FIG. 5 is a flowchart 500 of an example of processing steps to receive a modular connector within a connection jack 600 (hereinafter “jack”) according to embodiments herein. In addition, FIG. 6 is an example block diagram of a view of at least a portion of the connection jack 600 according to embodiments herein.

At step 510, receive at least a portion of a connector by the jack 600 in order to create a data connection between the modular connector and the jack 600. As shown in FIG. 6, the jack 600 has a receiving portion 610 into which a modular connector can be physically plugged in. The data connection is thereby created once the modular connector is secured within the jack's 600 receiving portion 610.

At step 520, receive light 630 at a light-conductive portion 620 of the jack 600. In one embodiment, the light 630 is provided by a light source associated with a circuit board in communication with the jack 600.

At step 530, receive the light 630 at an illuminative portion 640 of the jack 600. Here, the light-conductive portion 620 of the jack allows the light 630 to travel to the jack's illuminative portion 640. It is noted that the illuminative portion 640 and the light-conductive portion 620 illustrated in FIG. 6 are exemplary and are not meant to be limiting in any manner.

At step 540, illuminate the jack's illuminative portion 640 with the light 630 received from the light source. The illuminated illuminative portion 640 thereby displays the light 630 to indicate a status of the data connection between the modular connector and the jack 600. It is understood that the jack's illuminative portion 640 can be illuminated by different colors of light, where each particular color of light indicates a particular data connection status.

Note that the status-indicating connector 100 discussed in FIGS. 1-4 can be connected to any kind of computerized device such as a personal computer, a client computer system, server computer systems, workstation, portable computing device, console, laptop, network terminal, etc. This list is not exhaustive and is provided as an example of different possible embodiments.

In general, such computerized devices can include an interconnection mechanism, such as a data bus, motherboard or other circuitry that couples a memory system, a processor, an input/output interface, and a display. Those skilled in the art will understand that such computerized devices may include other processes and/or software and hardware components, such as an operating system.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

1. An apparatus, comprising:
a light-conductive housing of a connector;
an engagement portion attached to the light-conductive housing, the engagement portion for placing the connector in electrical communication with a circuit board;
an illuminative portion of the light-conductive housing, the illuminative portion to be illuminated by light delivered via the light-conductive housing of the connector; and
a light source integrated with the light-conductive housing, the light source to provide light to the light-conductive housing.

2. The apparatus as in claim 1, comprising:
a light-receptive portion of the light-conductive housing, the light-receptive portion to receive the light from a light source associated with the circuit board.

3. The apparatus as in claim 2, comprising:
wherein the illuminative portion of the light-conductive housing is illuminated by the light based on a current status of a connection between the engagement portion and the circuit board.

4. (canceled)

5. The apparatus as in claim 1, comprising:
a data transmission medium disposed within the light-conductive housing of the connector.

6. The apparatus as in claim 5, comprising:
wherein the illuminative portion of the light-conductive housing is illuminated by the light based on a current state of a data link between the data transmission medium and the circuit board.

7. The apparatus as in claim 6, wherein an exposed external surface of the illuminative portion of the housing surrounds at least a portion of the data transmission medium.

8. The apparatus as in claim 6, wherein the data transmission medium comprises a cable to transmit data to the circuit board while the connector is connected to the circuit board via the engagement portion.

9. (canceled)

10. A method, comprising:
connecting an engagement portion of a connector to a circuit board;
receiving light through at least a portion of a light-conductive housing of the connector;
indicating a status of a transmission link between the connector and the circuit board by illuminating at least an illuminative portion of the connector with the received light; and
receiving light from a light source integrated with the light-conductive housing of the connector.

11. The method as in claim 10, comprising:
receiving data via at least a portion of a transmission medium disposed within the connector.

12. The method as in claim 11, wherein receiving the data via at least a portion of a transmission medium includes:
receiving the data via at least a portion of a data transmission cable disposed within the connector.

13.-14. (canceled)

15. The method as in claim 10, wherein receiving the light includes:
receiving light of a particular color from a multi-colored light source, wherein a first light color received from the multi-colored light source indicates a first status of the transmission link and a second light color received from the multi-colored light source indicates a second status of the transmission link, wherein the first status differs from the second status, wherein the first light color differs from the second light color.

16. (canceled)

17. The method as in claim 10, wherein indicating the status of the transmission link between the connector and the circuit board includes:
indicating a status of a data transmission link created by contact, with the circuit board, of at least one pin disposed in the engagement portion of the connector.

18. The method as in claim 17, wherein indicating the status of the data transmission link created by contact of the at least one pin disposed in the engagement portion of the connector includes:
indicating the status of the data transmission link created by contact, with the circuit board, of at least one pin disposed on a modular connector.

19. An apparatus comprising:
at least one pin externally disposed on an engagement portion of a modular connector, the engagement portion to connect the modular connector to a circuit board;
a light-conductive housing of the modular connector;
an illuminative portion of the modular connector to be illuminated by the light delivered by at least a portion of the light-conductive housing, at least a portion of a data transmission medium disposed within the modular connector's light-conductive housing, wherein the illuminative portion of the modular connector is illuminated by the light based on a current state of a data link between the data transmission medium and the circuit board, the light provided by at least one light source integrated with the light conductive housing.

20. (canceled)
